(19) United States
(12) Patent Application Publication
(10) Pub. No.: US 2005/0052159 A1
(43) Pub. Date: Mar. 10, 2005

(54) Method and apparatus for overcharge protection using analog overvoltage detection

(76) Inventors: Stephen W. Moore, Fishers, IN (US); Richard Allen Rausch, Anderson, IN (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/658,641

(22) Filed: Sep. 9, 2003

(51) Int. Cl. H02J 7/00

(52) U.S. Cl. 320/134

(57) ABSTRACT

A protection circuit for a multi-cell lithium battery pack is disclosed. The protection circuit monitors and compares the battery pack voltage level and automatically disconnects the battery pack from a charging signal when a turn-off threshold level is reached. Overcharging is eliminated, while maximizing the amount of charge on the battery pack, and thus duration of use.

### TECHNICAL FIELD

The invention relates generally to energy-based systems, and in particular to a method and system of an overcharge protection circuit for a multi-cell battery pack, such as a lithium battery pack.

### BACKGROUND OF THE INVENTION

Various portable devices and appliances, such as cellular phones, require rechargeable batteries. Various types of rechargeable batteries are known to be used in such applications. For example, nickel-cadmium (NiCd), nickel metal hydride (NiMH) and lithium ion batteries are known to be used. Due to the different charging characteristics of such batteries, different battery chargers are required. For example, lithium ion batteries require constant current charging up to a certain voltage value and constant voltage charging thereafter. This constant current charging however may create what is referred to has an overcharge condition. One characteristic, however, of lithium chemistry batteries is that it has less tolerance to overcharging than other battery technologies. Excessive voltage may damage the active materials. In addition, overheating may occur as a result of prolonged overcharging of a battery causing the temperature of the battery to increase to an unacceptable level, possibly causing damage.

To address this problem, various battery protection circuits have been developed that limit charging to reduce the possibility of overheating of the battery cell. For example, a thermal protection circuit will disable the battery charging system when a maximum, threshold temperature is reached. Thermal detection is not a likely candidate for lithium batteries however, because heat generated by charging lithium batteries may follow overcharge, rather than heat generation preceding the overcharge. Therefore, a thermal protection circuit for a lithium battery is unpredictable and unreliable.

Another overcharge protection alternative is to utilize software based systems to limit charging times to reduce the possibility of overheating of a battery pack. These software systems monitor the battery pack voltage level and terminate fast charging when the battery pack reaches a preselected voltage level, for example 80 percent of the desired voltage level. Once the battery reaches this preselected level (percentage) of the desired voltage, rapid charging is terminated and a timer is enabled that allows trickle charging for a fixed period of time. There are disadvantages to this approach. For example, such software systems are unreliable as inaccurate readings can sometimes occur.

It is, of course, known to provide a charge control circuit (e.g., a battery control unit—BCU) that monitors and controls the charging of individual cells of a multi-cell battery pack. Shortcomings of such systems include their relatively high cost as well as their complexity, which rely on software with the characteristics noted above. Significantly, when the BCU fails for any reason to control charging as expected, the battery pack may suffer irreparable damage. Even an “overshoot” in the charging due to loss of control of the charging process could be catastrophic. Conventional approaches do not provide robust backup protection mechanisms in the event the BCU fails.

There is therefore a need for an overcharge protection circuit that minimizes or eliminates one or more of the above-identified problems.

### SUMMARY OF THE INVENTION

An object of the present invention is to solve one or more of the problems as set forth above. One advantage of the present invention is that it provides backup protection of the battery pack to prevent damage or failure due to overcharging, for example when a main control circuit fails. The present invention thus allows lithium battery applications, which have a greater intolerance to overcharging, to be used in an a wider variety of technologies, while eliminating extra circuitry and/or structure previously necessary to dissipate heat due to overcharging.

These and other features, objects and advantages are realized by the present invention, which includes a method of providing an overcharge protection circuit for a battery pack including the steps of determining a voltage level at the battery pack and automatically disconnecting a charging signal from the battery pack when a battery pack voltage level is reached. The present invention provides an important backup mechanism, when, for example, a primary control such as a BCU fails to control a charge control signal.

A system according to the invention is also presented.

### BRIEF DESCRIPTION OF THE DRAWINGS

The present invention will now be described by way of example, with reference to the accompanying drawings.

FIG. 1 is a simplified schematic and block diagram view of a battery pack according to the present invention, in an exemplary embodiment.

FIG. 2 is a circuit diagram showing, in greater detail, a overcharge protection circuit of the battery pack shown in FIG. 1.

FIG. 3A is a waveform graph illustrating outputs of a battery pack voltage level.

FIG. 3B is a graph illustrating the relationship between the battery pack voltage level and time.

FIG. 4 is a flow chart diagram illustrating a method in accordance with the present invention.

### DETAILED DESCRIPTION OF THE PREFERRED EMBODIMENT

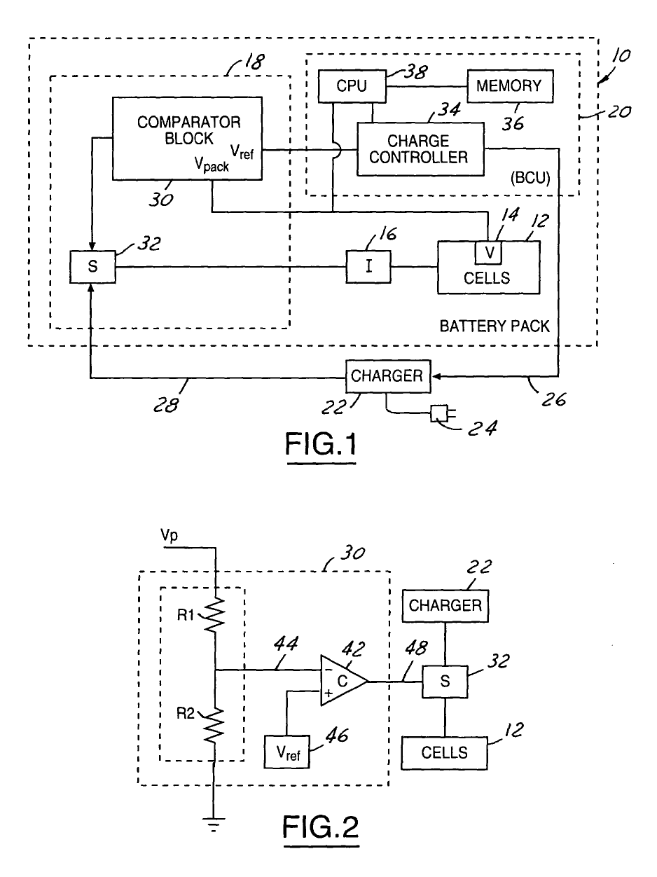

Referring now to the drawings wherein like reference numerals are used to identify identical components in the various views, FIG. 1 is a simplified schematic and block diagram view of an inventive battery pack 10 according to the invention. The present invention provides an important backup protection mechanism where a primary control, for example, a battery control unit (BCU), fails to control the charging as desired. The present invention is adapted to establish a selective trigger-activated control over the recharging process so as to minimize or eliminate overcharging conditions. The following description relates to a preferred overcharging protection circuit, capable of monitoring for the presence of an overvoltage condition at the battery pack.

In the illustrated embodiment, battery pack 10 includes one or more battery cells 12, a voltage sensor 14, at least one current sensor 16, a protection circuit 18 and a battery control unit (BCU) 20.

Cells 12 are configured to produce electrical power, and are also configured to be rechargeable, for example by receiving conventional electrical current, which is monitored by current sensor 16. The recharging current may be from either charger 22 or from a machine (not shown) operating as a generator. Cells 12 may comprise conventional apparatus according to known battery technologies, such as those described in the Background, for example, NiMH, PbA, or NiCd, or the like. In a preferred embodiment, however, cells 12 comprise cells formed in accordance with various Lithium chemistries known to those of ordinary skill in the energy storage art. In the illustrated embodiment, cells 12 may be arranged to produce a direct current (DC) output at a nominal level (e.g., 80 volts at 100% of full state of charge). It should be understood that the foregoing is exemplary only and not limiting in nature.

Voltage sensor 14 is configured to detect a voltage level and produce a voltage indicative signal representative of the detected voltage. In one embodiment, one voltage sensor 14 is provided to detect the overall output voltage of the combination of cells 12. However, in an alternate embodiment, sensor 14 may comprise a plurality of sensors, one for each cell 12, and provide a corresponding plurality of voltage indicative signals. Voltage sensor(s) 14 may comprise conventional apparatus known in the art.

Current sensor 16 is configured to detect a current level and polarity of the electrical (conventional) current flowing out of (or into) the battery pack and generate in response thereto a current indicative signal representative of the detected level and detected polarity. Current sensor 16 may comprise conventional apparatus known in the art.

FIG. 1 also shows an electrical battery charger 22, including in exemplary fashion a conventional electrical plug 24 for connection to a wall outlet (not shown) or the like. Charger 22 is configured for charging (or recharging) battery pack 10. Charger 22 may have an input configured to receive a charge control signal, such as a charge termination signal, on control line 26 from battery pack 10. The charge termination signal line 26 is configured to cause charger 22 to discontinue charging battery pack 10 (i.e., to stop charging), for example, when the battery pack 10 has been charged to a preselected voltage level according to the invention. Charger 22 may comprise conventional charging componentry known to those of ordinary skill in the art. Charger 22 may further include a power charging output on power line 28 configured for connection to battery pack 10 for charging (or recharging) the battery cells thereof. The power charging output of charger 22 is coupled to cells 12 by way of a switch 32.

Protection circuit 18 is configured to automatically disconnect the power charging signal being produced by charger 22 from the battery pack 10, particularly the cell 12 thereof, when a voltage level associated with the cells reaches a preselected turn-off threshold voltage level. Circuit 18 includes a comparator block 30 and a switch 32.

Comparator block 30 is configured to monitor and process an output from voltage sensor 14 and determine when a battery pack voltage level (V_{pack}) exceeds a preselected battery pack threshold Turn-Off level (V_{toff}) or when the battery pack voltage level (V_{pack}) has declined to a preselected battery pack threshold Turn-On level (V_{toff}). During start up when the battery pack voltage level (V_{Pack}) may be below either of these thresholds, the block 30 generates a switch control signal, which is provided to switch 32. When the battery pack voltage level (V_{Pack}) exceeds (e.g., due to excessive charging) the turn-off level, it discontinues generation of the switch control signal, which is provided to switch 32. When the battery pack voltage level (V_{Pack}) has declined from the turn-off level to the turn-on level, the switch control signal is again generated by comparator block 30.

Switch 32 is responsive to the switch control signal generated by comparator block 30. When the switch control signal is generated (asserted) by comparator block 30, switch 32 is configured to conduct power from charger 22 destined for cells 12 (through, for example, current sensor 16). However, when the switch control signal is discontinued, switch 32 responds by disconnecting the cells 12 from the power charging line output from charger 22. Switch 32 may be a Metal Oxide Semiconductor Field Effect Transistor (MOSFET) or other conventional apparatus known in the art.

With continued reference to FIG. 1, Battery Control Unit (BCU) 20 is configured for controlling the overall operation of battery pack 10, including the charging/recharging operation as well as any adjustments to a pre-determined charging strategy associated with battery pack 10. BCU 20 may include a charge controller 34, a memory 36, and a central processing unit (CPU) 38.

CPU 38 may comprise conventional processing apparatus known in the art, capable of executing preprogrammed instructions stored in memory 36. In this regard, memory 36 is coupled to CPU 38, and may comprise conventional memory devices, for example, a suitable combination of volatile, and non-volatile memory so that a main line software routine can be stored and yet allow further processing of dynamically produced data and/or signals.

Charge controller 34 is also coupled to CPU 38, and to protection circuit 18. Controller 34 is configured so as to allow CPU 38 to set a charge termination voltage such that when the actual voltage level from the battery pack 10 exceeds the set charge termination voltage, a charge termination control signal is generated on line 26. This charge termination control signal is operative to shut down external charger 22, as described above. Charge controller 34 may be configured as a separate unit or circuit, as illustrated, or may be implemented in software executed on CPU 38.

Charge controller 34 is further configured to provide threshold voltage levels to protection circuit, namely, the preselected battery pack threshold Turn-Off level (V_{toff}) and the preselected battery pack threshold Turn-On level (Vₜₒₙ). This two voltage levels establish a hysteresis band in which the battery pack output voltage level is controlled, as described more full below.

FIG. 2 is a schematic diagram showing, in greater detail, the comparator block 30 in protection circuit 18. As described in the Background, should the BCU lose control of the charge termination control signal 26, catastrophic results would occur to the cells 12 of the battery pack 10. Protection circuit 18 is configured to provide an important back-up protection mechanism to prevent such overcharging in the event BCU malfunctions and/or fails. Protection circuit 18 is configured to monitor and compare battery pack voltage levels independent of the external battery charger 22. Protection circuit 18 is adapted to work in conjunction with conventional battery pack charging systems and provides an additional level of battery pack protection in order to protect against operating conditions which can reduce or damage battery pack life. Comparator block 30 includes a voltage divider circuit 40, a comparator device 42 having an inverting (−) input coupled to a common node 44 of divider circuit 40, and a voltage reference 46 being provided on the non-inverting input (+) of comparator device 42.

Voltage divider 40 is configured to include a series circuit of resistors R1 and R2 that divides battery pack voltage (V_{Pack}) of each cell of the battery by a ratio defined by the values of R1 and R2 as known. The divided down resulting voltage (“scaled battery pack voltage”) is provided as an output on common node 44. Comparator device 42 configured to accept the scaled battery pack voltage output 44 on the inverting input (−) thereof. The voltage reference block V(_{REF}) 46 includes the preselected battery pack threshold Turn-On level (Vₜₒₙ) and preselected battery pack threshold Turn-Off level (V_{toff}) scaled down in the same fashion as the battery pack voltage level (V_{Pack}) by divider circuit 40.

Comparator device 42 is configured to compare the scaled battery pack voltage level on node 44 with the scaled turn-off threshold voltage level and turn-on threshold voltage levels. Switch 32 is responsive to an output signal 48 of comparator device 42 to automatically disconnect charger 22 from battery pack 10 via opening and/or closing of switch 32, thus eliminating overcharging of battery pack 10.

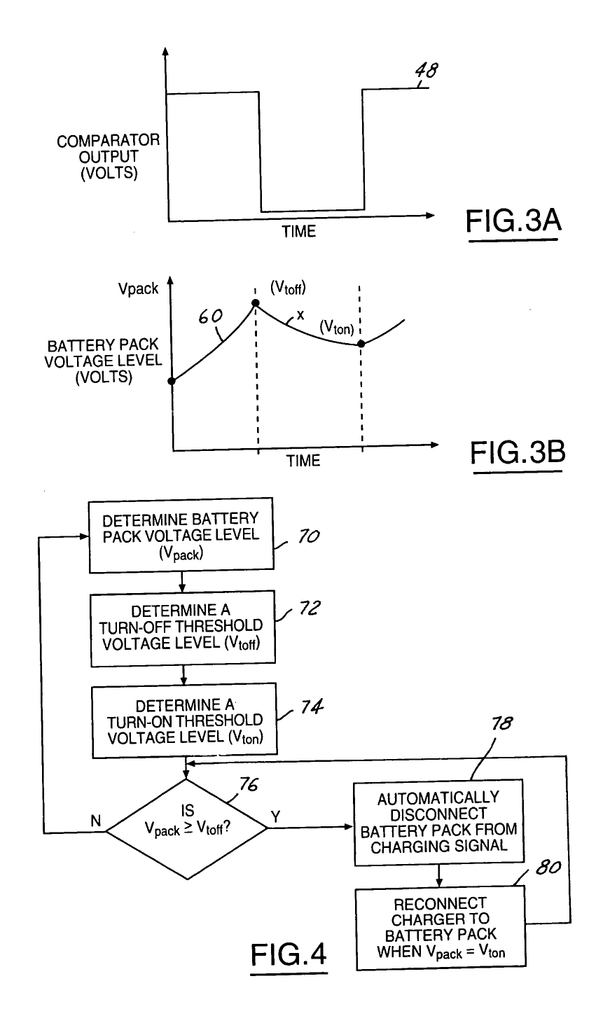

FIG. 3A illustrates a waveform output 48 of comparator device 42 and FIG. 3B shows the battery pack output voltage level.

As to FIG. 2, initially, the scaled battery pack output voltage on node 44 is less than the corresponding scaled threshold turn-off voltage reference being provided by block 46. The comparator output 48 (the “switch control signal”) is asserted since the voltage on the inverting input is less than that on the non-inverting input. Thus, as shown in FIG. 3B, the battery pack voltage level is charging (increasing) to a turn-off threshold voltage level (V_{TOFF}) while the comparator output 48 is asserted.

When the battery pack output voltage level exceeds the turn-off threshold voltage (V_{TOFF}), the switch control signal 48 is discontinued by comparator device 42, which causes switch 32 to “open”, automatically disconnecting a power charging signal from the cells of the battery pack. This change in state is because the scaled battery pack voltage level on node 44 is now equal to or slightly greater than the corresponding scaled turn-off level provided by block 46.

Thereafter, at point (χ) in curve 60 in FIG. 3B, the battery pack voltage level may relax while the cells of the battery pack are disconnected from charger 22. It is at this stage whereby the battery pack will reach an internal equilibrium controlled by a chemical process of a multi-cell lithium battery pack. Accordingly, the battery pack output voltage level diminishes until it reaches the turn-on threshold voltage level (V_{TON}).

At (V_{TON}), the scaled battery pack output voltage level on node 44 becomes equal to or less than the corresponding scaled turn-on threshold level, causing comparator 42 to assert the switch control signal, thereby automatically connecting a charging power signal to the cells of the battery pack via switch 32, allowing the battery pack to be charged to the turn-off level (unless control of the charging process is regained by charge controller 34 in the interim time). This is a continuous system, whereby the protection circuit ensures a certain level of protection irrespective and independent of a battery charger used to charge the battery pack.

As to FIGS. 3A and 3B, it warrants noting that the Vtoff level should be located above the BCU's normal control range, but below a catastrophic failure threshold level. Thus, by the time the invention engages, the battery pack may have exceeded the desired charge level but not by such a great level as to cause a catastrophic failure. Also, since the battery pack would not be charged to the BCU's preference, performance (permanent or temporary) may be compromised, although the achieving the object of saving the battery pack from catastrophic failure.

Referring now to FIG. 4, a method in accordance with the present invention will now be set forth. Step 70 determines the battery pack voltage levels. Step 70 may be performed by the substep of determining a scaled battery pack voltage output level using a voltage divider circuit 40, as described in connection with FIG. 2.

At step 72, a turn-off threshold voltage level (V_{TOFF}) is determined. This level may be above the normal range otherwise established by a properly operating BCU. This step may be performed by the substep of determining a corresponding, scaled turn-off threshold voltage level which would be scaled in the same manner as the battery pack output voltage level by voltage divider circuit 40.

At step 74, a turn-on threshold voltage level (V_{TON}) is determined. The turn-on threshold level may be selected to allow a suitable relaxing of the battery pack before reconnecting charger 22. Step 74 may be performed by the substep of determining a corresponding, scaled turn-on threshold voltage level which would be scaled in the same manner as the battery pack output voltage level by the voltage divider circuit 40.

At step 76, the battery pack voltage level is compared again the turn-off threshold level. If the battery pack voltage level is equal to or perhaps exceed the turn off threshold level, then the method proceeds to step 78. Otherwise, the method branches to step 70. Step 76 may be performed by the substep of comparing the scaled battery pack output voltage (i.e., output on node 44 from voltage divider circuit 40) with the corresponding scaled turn off threshold voltage level, as implemented with comparator device 42.

In step 78, the method automatically disconnects the battery pack from the charger (and thus the charging power signal). The method proceeds to step 80.

In step 80, the method will automatically reconnect the battery pack to the battery charger (and thus the charging power signal) when the battery pack output voltage level declines to the turn-on threshold level. This step may be performed by the substep of reconnecting when the scaled battery pack output voltage level declines to the scaled turn-on threshold level.

1. A method of providing overcharge protection of a battery pack comprising the steps of:
determining a voltage level at said battery pack; and
automatically disconnecting a charging signal from said battery pack when said battery pack voltage level reaches a turn-off threshold voltage level.

2. The method of claim 1 further including the steps of:
determining the turn-off threshold voltage level;
determining a turn-on threshold voltage level; and
wherein said automatically disconnecting step includes the substeps of:
generating an output signal when said battery pack voltage level reaches said turn-off threshold voltage level; and
opening a switch coupling a charger that produces said charging signal and said battery pack responsive to said output signal.

3. The method of claim 2 further including the steps of:
discontinuing said output signal and generating a connect signal when said battery pack voltage level reaches said turn-on threshold voltage level; and
closing said switch coupling said charger that produces said charging signal and said battery pack responsive to said output signal.

4. The method of claim 1 further including the step of scaling a voltage level at said battery pack to obtain a scaled battery pack voltage level as determined by a voltage divider.

5. The method of claim 1 further including the step of comparing said battery pack voltage level to said turn-off threshold voltage level.

6. The method of claim 2 further including the step of comparing said battery pack voltage level to said turn-on threshold voltage level.

7. A protection circuit for a battery pack comprising:
a comparator device for comparing a battery pack voltage level to a turn-off threshold voltage level; and
a switch coupled between a charger and said battery pack responsive to an output signal.

8. The protection circuit of claim 7 wherein said comparator device compares said battery pack voltage level to a turn-on threshold voltage level.

9. The protection circuit of claim 7 wherein said switch automatically disconnects a charging signal from said battery pack when said battery pack voltage level exceeds said turn-off threshold voltage level.

10. The protection circuit of claim 9 wherein said switch automatically connects a charging signal from said battery pack when said battery pack voltage level is less than said turn-on threshold voltage level.
